(19) United States
(12) Patent Application Publication
(10) Pub. No.: US 2012/0247808 A1
(43) Pub. Date: Oct. 4, 2012

(54) TRANSPARENT CONDUCTIVE MATERIAL

(76) Inventor: Si-Ty Lam, Pleasanton, CA (US)

(21) Appl. No.: 13/260,236

(22) PCT Filed: Jun. 22, 2009
(86) PCT No.: PCT/US2009/048121

§ 371 Date: Dec. 20, 2011

(51) Int. Cl. H01B 1/04; C25D 5/02; B05D 5/12; C25D 5/54; B82Y 99/00

(52) U.S. Cl. 174/126.2; 427/122; 205/159; 205/118; 977/742

(57) ABSTRACT

A transparent conductive material, including a substantially transparent carbon nanotube layer, and a metal layer deposited onto the carbon nanotube layer, in which the metal layer increases an electrical conductance of the transparent conductive material without substantially reducing an optical transmittance of the transparent conductive material.

### BACKGROUND

With the development of newer technologies relating to display devices, bio-sensing devices, and energy conversion devices, among others, a need for conductive materials that are also transparent has emerged. Several applications that have been developed use transparent conducting films that act both as a window for light to pass through to an active material beneath and as an ohmic contact for charge carrier transport from an electrical energy source. However, some transparent conducting films are very brittle and not suitable for flexible display or flexible electronic applications, in part, because of their susceptibility to cracking. Such films can also be relatively expensive.

In order to overcome these problems, transparent conducting films have been developed using carbon nanotube networks or other materials. One issue that some of these films encounter is a high electrical resistance, which can interfere with the optimal operation of the device.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a graph illustrating sheet resistance versus transmittance of various carbon nanotube films without metal plating, according to principles described herein.

FIG. 2 is a scanning electron microscope image of a carbon nanotube film, according to principles described herein.

FIG. 3 is a scanning electron microscope image of a carbon nanotube film with a metal plating, according to principles described herein.

FIG. 4 is a graph illustrating transmittance of various carbon nanotube films before and after receiving a metal plating, according to principles described herein.

FIG. 5 is a graph illustrating sheet resistance versus transmittance of samples of carbon nanotube films with metal plating compared to indium tin oxide films, according to the principles described herein.

FIG. 6 is a flowchart illustrating a method for creating a transparent conductive material, according to the principles described herein.

Throughout the drawings, identical reference numbers designate similar, but not necessarily identical, elements.

### DETAILED DESCRIPTION

The present specification relates to transparent conductive materials. Such materials may be used in applications including, but not limited to, display devices, energy conversion, biosensing devices, and others. Particularly, the present specification relates to a flexible transparent conductive material made using a carbon nanotube film having a metal plating that decreases the electrical resistance and increases the conductivity of the material without reducing or substantially reducing the optical transmittance of the material.

One type of film that may be used in applications that require transparent conducting films, such as information display devices, is an indium tin oxide (ITO) film. ITO films are generally quite brittle and are not suitable for a flexible display device or flexible electronic applications because, in part, of their susceptibility to cracking. ITO films may also be relatively expensive, thereby increasing production costs and costs to consumers.

In order to produce transparent conducting films more suitable for flexible displays and flexible electronic applications, developments have been made in relation to carbon nanotube films for such purposes. Carbon nanotube (CNT) films are much more flexible and resistant to cracking and breaking than many other types of transparent, electrically conducting films. The physical structure and light transmission properties of carbon nanotube films would make them well suited for use as electrodes in flexible displays and flexible electronic applications.

Carbon nanotubes are excellent conductors, but the junctions between individual carbon nanotubes (205) in a network of nanotubes have a much higher resistance than the carbon nanotubes (205) themselves. Consequently, the overall resistance of a network of carbon nanotubes (205) is much higher than the resistance of each individual carbon nanotube. As the carbon nanotube film is adjusted to have a lower resistivity, the transmittance of the carbon nanotube film is lowered as well. Consequently, the electrical properties of the carbon nanotube films by themselves are inadequate for some applications using transparent conducting films due to the high electrical resistivity of the carbon nanotube film. Very high amounts of voltage or current may be required to drive a circuit that uses groups of many cells or components using carbon nanotube films, negating their effectiveness in some systems.

As used in the present specification and in the appended claims, the term “film” is broadly interpreted to include a layer, deposit, coating or the like that covers some or all of a given material or surface. The film may be any thickness sufficient for the appropriate application and may be porous or non-porous.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

Transparent, electrically conducting films are often used in photovoltaic applications and allow a variety of functions to be performed due to their optical and electrical properties. The films may act as a window for light to pass through—in the visible range for some devices and in other spectrums for other devices—depending on the desired capabilities of the device. The films also act as an ohmic contact for charge carrier transport from an electrical energy source.

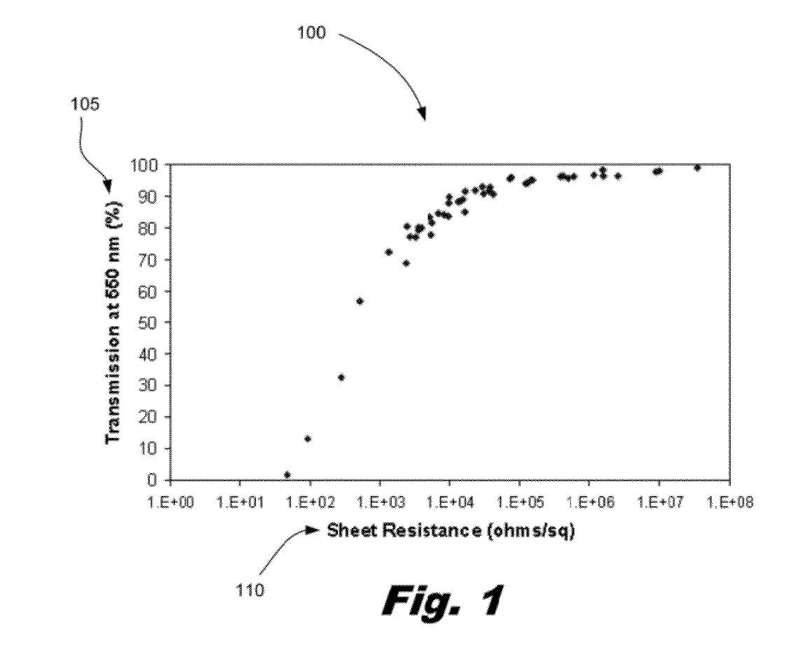

The graph (100) in FIG. 1 represents actual measurements taken from various samples of carbon nanotubes-only films with respect to the light transmission capabilities, or transmittance (105), of the samples, on the y-axis, in relation to their sheet resistance (110), on the x-axis. The sheet resistance (110) is a measure of resistance of a film with a uniform thickness. Sheet resistance (110) is directly measured to provide an accurate and actual resistance of the samples, rather than a calculated or theoretical resistance of the samples. Additionally, when measuring sheet resistance, current flows along the plane of the film being measured. In the present embodiment, the sheet resistance (110) is given in terms of ohms per square (ohm/sq) and the graph displays a range from 1 ohm/sq to 100 megohm/sq. “Square” is used to signify an aspect ratio, such that any square sheet of the same properties has the same actual resistance, regardless of the size of the square sheet.

The transmittance (105), measured using light at 550 nanometers (nm), is shown as a percentage of the light that is able to pass through the carbon nanotube film, ranging from 0% to 100%. 550 nm light is located in the middle of the visible spectrum, which ranges from about 380 to 750 nm.

As shown in the graph of FIG. 1, carbon nanotube film samples that were made to have higher transmittance (105) also had higher sheet resistance (110). Samples with a transmittance (105) of 90% or higher tended to have a sheet resistance (110) of about 10 kohm/sq up to as much as about 50 megohm/sq. Additionally, samples that had lower, usable sheet resistance (110) had much lower transmittance (105) such that the samples would be very poor transparent conductive films.

Consequently, the carbon nanotubes samples used to produce the data shown in the graph, while flexible, are not useful for electronic applications requiring low resistivity, particularly in high speed applications. Higher resistivity materials resist movement of electrical charge and, in ohmic contacts particularly, can greatly affect the response time and overall speed of a system, and many times can render the system unusable. For example, sensors employing carbon nanotube films of the art may experience a slow recovery of the carbon nanotubes to an initial state.

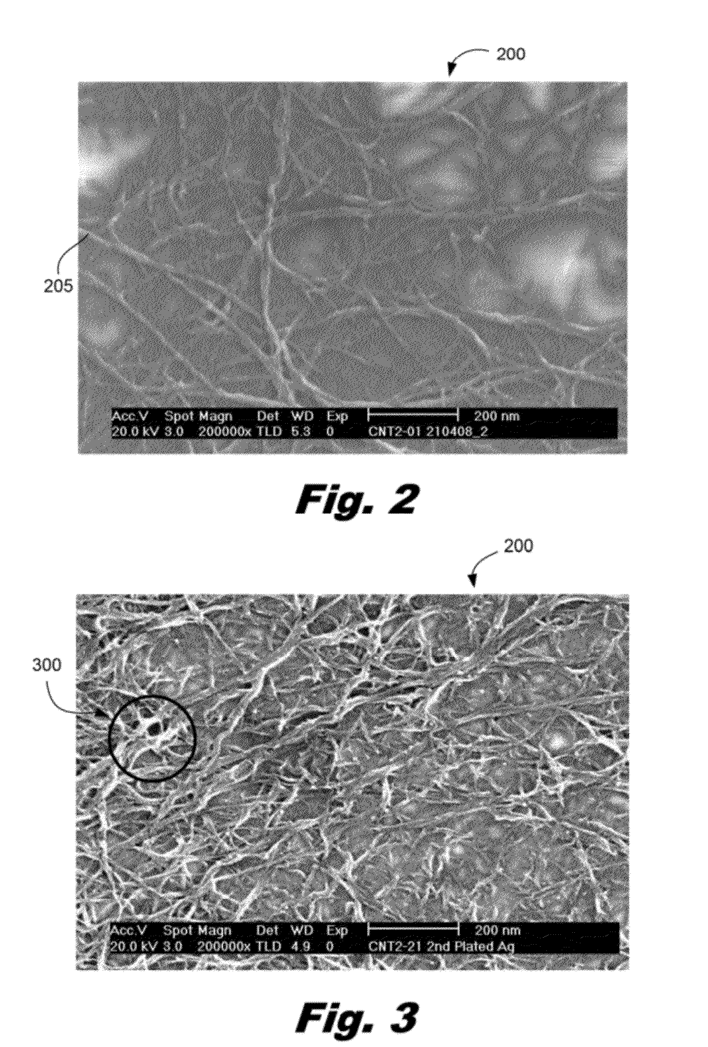

FIG. 2 is an image taken by a scanning electron microscope (SEM) of a transparent, electrically conductive material, which is also a carbon nanotube film (200). Carbon nanotubes (205) may be formed using a variety of different methods, including in an arc discharge process, laser ablation, and chemical vapor deposition.

During formation, carbon nanotubes naturally align themselves into ropes or bundles held together by Van der Waals forces, which are forces between molecules. To produce uniform thin films from these carbon nanotubes, the nanotubes are first debundled.

Carbon nanotubes (205) have incredibly high tensile strength, which is the amount of longitudinal stress that the material can possess without materially breaking or permanently deforming. Carbon nanotubes (205) also have a high coefficient of elasticity, allowing the carbon nanotubes to be bent, pulled, and twisted without easily causing permanent damage to the structure of the carbon nanotube film. This makes such films well suited for applications that require flexibility. Carbon nanotubes (205) can also be metallic or semiconducting which can allow for helpful combinations in many applications.

Because carbon nanotubes (205) can have a very small diameter as small as 1-2 nm, carbon nanotube films (200) can have a thickness as thin as 10-100 nm. This may allow for thin layers of carbon nanotube networks to be produced that cover a fairly large area. The formation of the carbon nanotube networks may also allow for a porous film (200), which may increase the transmittance of the film. Additionally, carbon nanotube films (200) can have high coating uniformity such that the sheet resistance is substantially uniform across the entire film.

As noted, there are a variety of ways to form carbon nanotubes. In an arc discharge process, carbon nanotubes (205) are formed as a result of carbon contained in a negative electrode that sublimates or vaporizes and then condenses as a result of high discharge temperatures during an arc discharge with a high current.

In a laser ablation process, a pulsed laser vaporizes a graphite target in a high-temperature reactor while an inert gas is bled into the chamber. The carbon nanotubes (205) develop on cooler surfaces of the reactor as the vaporized carbon condenses.

In a chemical vapor deposition process, a substrate is prepared with a layer of metal catalyst particles. After heating the substrate to a temperature of about 700 to 900 degrees Celsius, a process gas and a carbon-containing gas are bled into the reactor holding the substrate, causing carbon nanotubes (205) to grow at the sites of the metal catalyst. The type of catalyst, particle size, and catalyst preparation techniques determine the yield and quality of the carbon nanotubes (205). The catalyst may be prepared using a solution-based technique or through a physical process such as sputtering or e-beam deposition.

A particular raw carbon nanotube material for depositing films as described herein is formed by arc discharge resulting in ultra high purity single walled carbon nanotubes (SWNT). Before depositing carbon nanotube material to form a film (200), the raw carbon nanotube powder is first debundled into individual tubes by processing the carbon nanotubes into a dispersion. Mechanical and or chemical treatments may be used to achieve debundled solutions. In some embodiments, nanotubes are processed into a dispersion in order to achieve individual tubes using a sonication tip with the aid of a surfactant in a dispersion.

A carbon nanotube film (200) can then be formed by depositing the debundled dispersion on a substrate using spray coating, inkjet printing, gravure coating or vacuum filtration among other techniques. The carbon nanotube films of the current embodiment (200) were formed by spray coating, followed by washing in de-ionised water to remove residual surfactant from the films. Further details of the formation of carbon nanotube-based dispersions can be found in W.I.P.O Patent Application No. 2009029570 to Sheehan et al., which is hereby incorporated by reference for all that it contains.

The substrate on which the carbon nanotubes network is coated may be made from silicon, mica, quartz, alumina, glass, plastic or another material. One example of a substrate used in many applications using transparent conducting films is polyethylene terephthalate (PET). PET film has a high tensile strength, chemical and dimensional stability, high optical transparency and low reflectivity, gas and aroma barrier properties, and electrical insulating properties. These properties may make it useful in flexible display applications.

In order to adapt carbon nanotube films for use in electrical applications that require low electrical resistivity and high transparency, however, the resistivity of the carbon nanotube films may need to be adjusted. Some methods of creating and treating carbon nanotube films may produce films with a lower resistivity than other methods, though the resistivity may still not be low enough for use in some applications.

FIG. 3 is an image taken by an SEM of a metal-plated carbon nanotube film (200) after a metal layer (300) has been deposited by plating on the surface of the film, as can be seen by the bright spots with an excellent contrast in the image, one area of which has been circled. The image is magnified such that a reference line in the image is equal to 200 nm in length, as indicated. This magnification allows the carbon nanotubes network to be shown in sufficient detail to see individual tubes in the network.

The metal layer (300) in this embodiment is silver, though other metals such as gold, copper, nickel, iron or other metals may alternatively be used. The metal layer (300) may also be made using more than one metal or a metal alloy such as gold-silver, copper-silver, nickel-silver, nickel-iron alloy. The type of metal or metals used for the metal layer (300) determines some of the electrical and magnetic properties of the transparent conductive material. Some applications in which such carbon nanotube films may be used include light emitting diodes, organic light emitting diodes, e-paper, solar cells, electrochromic and electrophoretic devices, sensors, biosensors, speakers, polymer-dispersed liquid crystals, touch screen displays, and liquid crystal displays, among others.

Four point probe measurements of the film (200) before and after plating determined that the sheet resistance was reduced from 2.7 kohm/sq to 1.04 kohm/sq for the silver-plated carbon nanotube film of FIG. 3. This is a reduction of more than half the sheet resistance. Consequently, the conductivity of the carbon nanotube film (200) was increased when the metal layer was added.

The metal layer (300) may be deposited on the surface of the carbon nanotube film (200) using either electro or electroless deposition processes. Electrodeposition processes, or electroplating (also simply referred to as plating) use electrical current to reduce positively charged ions—cations—of a desired material from a solution and coat a conductive object, such as the carbon nanotube film, with a small amount of the metal. The electroplating process is analogous to a galvanic cell acting in reverse. The surface to be plated is the cathode of the circuit.

In one such process, an anode may be made of the metal or material to be plated on the surface. Both the cathode and the anode are immersed in an electrolyte solution having free ions that behaves as an electrically conductive medium. The electrolyte solution has one or more dissolved metal salts in addition to the free ions that permit the flow of electricity. A rectifier is connected to both the anode and the cathode, the anode being connected to the positive terminal of the rectifier, and the cathode being connected to the negative terminal of the rectifier. The rectifier supplies a direct current to the anode in order to oxidize the anode metal in order to create cations, which, in turn, associate with free anions in the electrolyte solution.

At the cathode, the dissolved metal ions in the solution are reduced at the interface between the solution and the cathode, resulting in the ions plating onto the cathode. The plating rate depends on the dissolution rate of the anode in relation to the current flow. The ions in the solution are continuously replenished by the anode. Other electroplating processes may use a nonconsumable anode such as lead or platinum, such that the ions of the metal to be plated must be periodically replenished in the solution as the ions are plated onto the solution. Electroplating processes are generally used to plate single metal elements, though some alloys are able to be deposited in an electroplating process. Electroplating processes may also use more than two electrodes.

An electroless plating process may be used instead of an electroplating process. The electroless plating process may allow some metals to be plated on the carbon nanotube film (200) which could not otherwise be plated using an electroplating process. Electroless plating processes rely on the presence of a reducing agent in a chemical bath which reacts with the ions of a metal source to deposit the metal on the carbon nanotube film (200). One common form of electroless plating is electroless nickel plating. Unlike in an electroplating process, no external source of current is needed in order for the solution to form a deposit. Electroless plating processes can help eliminate flux-density and power supply issues, can deposit evenly regardless of the geometry of the surface, and can be deposited on non-conductive surfaces with the use of a proper catalyst. Such processes also may allow for certain alloys to be deposited onto the surface, such as a nickel-iron alloy.

Before using an electroless plating process, the surface to be plated may be cleaned during a pre-treatment process in order to remove unwanted contaminants from the surface that could result in poor plating, followed by a water-rinse to remove the cleaning chemical. In one example using an electroless nickel plating process, the plating bath may include sodium hypophosphite, which reacts with the metal ions to deposit metal. Other examples may include other solutions which deposit metal ions of certain metal elements such as gold, silver, copper or their alloys according to the solution used. After plating, the plated materials may need to be finished with an anti-oxidation solution and rinsed in water in order to prevent stains on the plating.

Some advantages of an electroless plating process may include the ability to form the plating without using electrical power, an even coating on some or all of the surface may be achieved, flexibility in plating volume and thickness, and different surface finishes can be obtained, among other possible advantages. However, the lifespan of the chemicals used may be limited, and the waste treatment cost may be high due to the need to continuously renew the chemicals.

An important distinction to be made according to the present specification is that the process used to plate the carbon nanotube film (200) with a metal layer (300) does not necessarily create a layer of metal over the entire surface of the carbon nanotube film, as opposed to other methods of metallizing or coating a surface with a metal plating, such as sputtering, chemical vapor deposition, laser ablation, or e-beam evaporation. The electroplating or electroless plating or deposition processes allow for a minute amount of the metal to be deposited on the carbon nanotube film. The metal layer has a geometry that does not interfere with or lower the transmittance of the transparent conducting film.

In one embodiment, the metal is deposited only on a portion of the carbon nanotube film (200) near or on the junctions between each carbon nanotubes (205). The metal or metals deposited on the carbon nanotube film (200) have a higher conductivity and lower electrical resistance than the junctions between carbon nanotubes. By depositing the metal at and around the junctions, electrical charges are able to travel between carbon nanotubes (205) through the metal deposited at each junction. The deposits of metal on the carbon nanotube film (200) result in lower junction resistances. Consequently, the overall conductivity of the transparent conducting film is improved.

In other embodiments, metal particles may be deposited on the carbon nanotubes (205) such that they cover more of the carbon nanotube film (200) than just at the junctions. However, a larger amount of metal deposits can result in reduced optical transmittance, so the amount of metal deposited is preferably small enough such that the metal has no effect on the transmittance, though any amount of metal may be used according to the requirements of each application.

The metal layer (300) may be made of very minute deposits that are not visible or are barely visible using an SEM. The thickness of the deposits may be as small as 10 nm or even 1 nm or less on the carbon nanotubes (205) and may require a more advanced imaging system capable of seeing the deposits such as a transmission electron microscope (TEM) in order to be able to see the deposits. The deposits may be thicker at the junctions than on the carbon nanotubes (205) in non-junction locations. The variations in thickness may be a natural result of depositing the metal layer (300) using the processes as described herein. The junctions between carbon nanotubes in the carbon nanotube film may have an enhanced electrical field over non-junction locations in the film, thereby attracting a higher concentration of metal deposits during the deposition process.

By using a transparent conducting film of carbon nanotubes with a deposit of conductive metal, the performance of the film would be sufficient to operate in an application such as a liquid crystal display (LCD). The carbon nanotube film would provide flexibility for the display that would otherwise not be possible using ITO films.

A flexible display would prevent cracking of the display if the device was dropped or if an object impacted the display. This may be particularly helpful in cellular phones and other mobile devices that are frequently subject to impact forces, such as being dropped on the ground or from objects located in the same pocket or region as the mobile device.

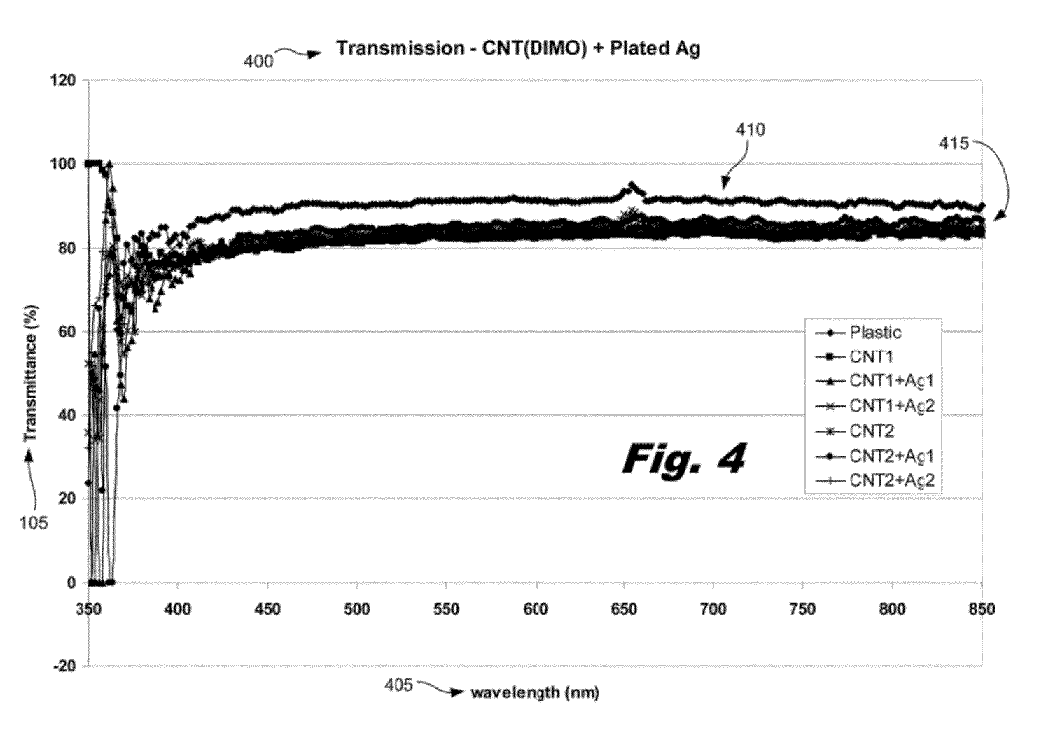

FIG. 4 shows a graph of a transmittance analysis (400) of several different carbon nanotube film samples (415) and a plastic sample (410) using light having a wavelength between 350 nm and 850 nm. This includes the visible light spectrum, which falls between about 380 nm and 750 nm. The transmittance (105) to such light is shown by the y-axis and wavelength (405) is shown by the x-axis. The carbon nanotube film samples (415) include carbon nanotube films without a metal plating and carbon nanotube films with silver metal platings.

In the spectrum shown, the non-plated carbon nanotube films have a transmittance between about 80 and 90 percent, and the metal plated carbon nanotube films using silver have a transmittance within the same range of about 80 to 90 percent. The plastic sample (410) has the highest transmittance, shown by the top line. Wavelengths above 850 nm are not shown, but the properties of the carbon nanotube film may be such that the films are equally efficient at transmitting light with longer wavelengths. Between about 350 nm and 375 nm, the carbon nanotube films each have somewhat different responses, but the curves begin to level off at about 375 nm. As can be seen, the carbon nanotube films have about the same optical transmittance, regardless of whether the film is plated or not.

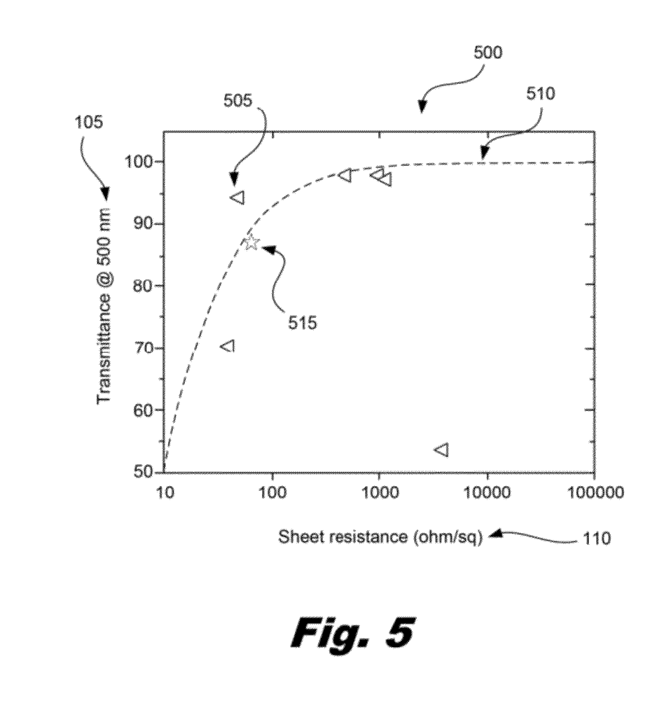

The graph in FIG. 5 shows a comparison (500) for the optical transmittance versus sheet resistance of a carbon nanotube film with a gold plating as compared to a typical optical transmittance versus sheet resistance point for an ITO film. The transmittance (105) is measured at 550 nm and is shown on the y-axis. The sheet resistance (110) uses a logarithmic scale and is displayed on the x-axis.

Both the carbon nanotube film and the ITO film are located on a polyethylene terephthalate (PET) substrate. The PET substrate is useful with the carbon nanotube film due to its physical properties that allow the carbon nanotubes on PET to remain flexible.

As can be seen in the figure, the transmission versus sheet resistance samples for the carbon nanotube film, represented by the triangles (505), and the general curve, shown by the dashed line (510), are comparable to a typical transmittance versus sheet resistance sample of ITO represented by the star (515). In fact, the transmission versus sheet resistance samples for the carbon nanotube film even shows samples that have better transmittance under 100 ohm/sq sheet resistance. The carbon nanotube films may have a sheet resistance under 50 ohm/sq. Because the carbon nanotube films with a metal plating show comparable electrical resistivity as ITO films and high transmittance, carbon nanotube films may be an improvement over the prior art ITO films in that they will allow for better flexibility of the displays at a reduced cost.

In general, the carbon nanotube films having a metal plating show substantial similarity in optical transmittance to the non-plated carbon nanotube films and improvement in their electrical properties over the non-plated carbon nanotube films, as shown in FIGS. 4 and 5. Consequently, it can be determined that the metal plating is an effective method of improving the conductivity of the carbon nanotube film without reducing the optical transmittance in the visible spectrum.

According to one embodiment of the present specification, a carbon nanotube film may be plated with a nickel, nickel-iron alloy, or other nickel alloy blend. The resulting film may exhibit magnetic properties or other properties that may allow the film to be used in a bio-sensing device which makes measurements or detections based on the magnetic properties of the sensed material, such as in magnetic resonance imaging (MRI). The type of metal or alloy used in the metal layer may make the film sensitive to electromagnetic radiation by improving the ferromagnetic properties of the film such that the film may allow a device to detect or induce changes in magnetic fields of an object. Another example may include a bio-sensing device that is able to measure or detect levels of iron components in blood cells due to the magnetic properties of iron.

For applications that require a high conductivity, metals with a high conductivity may be particularly useful, such as silver or gold. Such metals are typically used in high speed circuits and other applications that require low resistivity and high conductivity to operate effectively. One embodiment of a system that may require transparent conducting film with a high conductivity and a high transmittance is a liquid crystal display (LCD). LCDs are display devices used in televisions, computer monitors, and other devices that are made up of any number of pixels filled with liquid crystals and arrayed in front of a light source.

Each pixel may be made up of a layer of molecules aligned between two transparent conducting films and two polarizing filters. In order for the LCD pixels to work, the transparent conducting films must be able to act as electrodes and at the same time allow light to pass from the light source through the filters and films in order to be projected to the viewer. If the optical transmittance is not sufficiently high, the projected image may be dim or the colors that a viewer sees may be altered from the intended image. Additionally, if the transparent conducting films have a high resistivity, the high number of films in the display due to the large number of pixels will increase the overall resistivity of the display and require a large voltage or current source in order to supply each pixel with enough power to operate.

In another embodiment, the carbon nanotube films are used in conjunction with a foldable or rollable display. The foldable display may be a thin portable display that may be folded or rolled such that the display may be stored or carried in a smaller volume than the area of the unfolded display. The display may also be a thin image display that may be attached to another surface or object, for example an organic light emitting diode display on a t-shirt. In such an embodiment, the display may be programmed to display a predetermined image, or the display may be programmed to have several. Such a display may be resistant to cracking and allow the t-shirt to fit comfortably and have a light weight. In another embodiment, the display may be on a foldable map that changes according to input given or that may be preloaded with a map of a specific area.

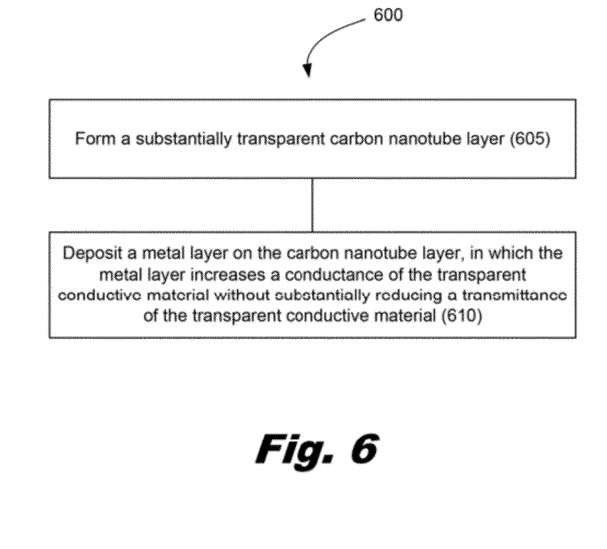

FIG. 6 illustrates a method (600) for creating a flexible transparent conductive material includes forming (605) a substantially transparent carbon nanotube layer, and depositing (610) a metal layer on the carbon nanotube layer. The metal layer increases a conductance of the transparent conductive material without substantially reducing the optical transmittance of the transparent conductive material. The metal layer or plating is deposited using an electroplating or electroless plating process such that the metal plating is deposited at the junctions between carbon nanotubes in the carbon nanotube film. The amount of metal deposited may be very small and does not necessarily cover the entire surface of the carbon nanotube film, but may only cover portions. Consequently, the metal plating may have a porous geometry. The thickness of the metal layer may be as small as 10 nm or even 1 nm or less. The metal layer may include a metal alloy. The resulting sheet resistance of the transparent conductive material after depositing the metal layer on the carbon nanotube film may be less than 50 ohm/sq, which may be ideal for high-speed or low power applications.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A transparent conductive material, comprising:
a substantially transparent carbon nanotube layer; and
a metal layer deposited onto said carbon nanotube layer,
in which said metal layer increases an electrical conductance of said transparent conductive material without substantially reducing an optical transmittance of said transparent conductive material.

2. The transparent conductive material of claim 1, in which said metal layer does not completely cover said carbon nanotube layer.

3. The transparent conductive material of claim 2, in which said metal layer is thicker at junctions between carbon nanotubes than at non-junction locations in said carbon nanotube layer.

4. The transparent conductive material of claim 1, in which said transparent conductive material is flexible.

5. The transparent conductive material of claim 1, in which said metal layer comprises a metal alloy.

6. The transparent conductive material of claim 1, in which said metal layer comprises a magnetic material having magnetic properties.

7. The transparent conductive material of claim 6, in which said magnetic material comprises nickel.

8. The transparent conductive material of claim 1, in which said metal layer comprises a thickness less than 10 nm.

9. The transparent conductive material of claim 1, further comprising a sheet resistance less than 50 ohm/sq.

10. A method for creating a transparent conductive material, comprising:
forming a substantially transparent carbon nanotube layer; and
depositing a metal layer on said carbon nanotube layer,
in which said metal layer increases an electrical conductance of said transparent conductive material without substantially reducing an optical transmittance of said transparent conductive material.

11. The method of claim 10, further comprising not depositing said metal layer over all of said carbon nanotube layer.

12. The method of claim 10, further comprising depositing said metal layer such that said metal layer is thicker at junctions between nanotubes of said carbon nanotube layer than at non-junction locations.

13. The method of claim 10, in which said metal layer comprises a metal alloy.

14. The method of claim 10, in which said metal layer comprises a thickness less than 10 nm.

15. The method of claim 10, in which said depositing said metal layer is performed by electrodeposition, electroplating or electroless plating.
